(19) United States
(12) Patent Application Publication
(10) Pub. No.: US 2009/0143135 A1
(43) Pub. Date: Jun. 4, 2009

(54) Slot machine having symbols classified in colors and control method thereof

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/216,782

(22) Filed: Jul. 10, 2008

Related U.S. Application Data
(60) Provisional application No. 60/996,758, filed on Dec. 4, 2007.

(51) Int. Cl. A63F 9/24; A63F 13/00

(52) U.S. Cl. 463/20

(57) ABSTRACT

A slot machine of the present invention comprises: a display capable of rearranging a plurality of colored symbols or a plurality of symbols each having a colored background; and a controller programmed to execute processing of: (A) rearranging the plurality of symbols to the display; (B) determining an amount of a normal payout, based on the numbers of symbols of respective types rearranged in the processing (A); (C) determining an additional payout condition relating to colors; (D) determining an amount of an additional payout, based on at least the colors of the symbols rearranged in the processing (A) or at least the colors of the backgrounds of the symbols, and the additional payout condition determined in the processing (C); and (E) paying out game media corresponding to the amount of the normal payout determined in the processing (B) and game media corresponding to the amount of the additional payout determined in the processing (D).

### CROSS-REFERENCE TO RELATED APPLICATIONS

This application claims benefit of priority based on U.S. Provisional Patent Application No. 60/996,758 filed on Dec. 4, 2007. The contents of this application are incorporated herein by reference in their entirety.

### BACKGROUND OF THE INVENTION

1. Field of the Invention

The present invention relates to a slot machine having symbols classified in colors thereof and a method for controlling the same.

2. Discussion of the Background

In conventional slot machines, when a player inserts game media such as medals, coins or bills into an insertion slot of the slot machine and presses a spin button, then a plurality of symbols are scroll-displayed to a display portion provided on the front surface of a casing and, thereafter, the respective symbols are automatically stopped, as disclosed in U.S. Pat. Nos. 6,960,133, 6,012,983 and 6,093,102. In this case, when scroll-display of respective symbols starts by an input from the spin button, symbols are selected using random numbers, and the selected symbols are stop-displayed to the display portion. Then, when a combination of the stop-displayed symbols along a winning line is a predetermined winning combination (prize), a payout is conducted.

As described above, whether or not a payout is conducted depends on whether or not a predetermined combination of symbols is established along the winning line, and therefore, a player usually plays games while focusing his or her attention on the winning line and expecting the establishment of a predetermined combination of symbols along the line. Further, usually, the player concentrates on the winning line, and therefore, when a predetermined combination of symbols is stop-displayed along the line and a payout is conducted, the player can easily understand the meaning of the payout, that is, which prize has been established to conduct the payout.

Further, among conventional slot machines, there are some slot machines which conduct two types of payouts which are a payout determined according to the combinations of symbols rearranged along winning lines and a payout determined according to the number of displayed scatter symbols, as disclosed in U.S. Pat. No. 6,604,999 and US 2002-0065124-A1. In such a slot machine which conducts payouts based on such scatter symbols, there is no relationship between payouts and positions at which the scatter symbols are displayed.

Particularly, a slot machine which employs symbols all of which are constituted by scatter symbols (hereinafter, referred to as an all-scatter type slot machine) employs no concept of winning lines. That is, such a slot machine determines payouts regardless of the positions of symbols displayed to the display portion.

Such an all-scatter type slot machine fails to cause a player to focus his or her attention on a certain position such as a winning line, usually resulting in a difficulty for the player to grasp positions and types of rearranged symbols. Therefore, there is a higher possibility that the player can not immediately grasp the number of scatter symbols displayed to the display portion. As a result, even when a payout is conducted to the player based on the number of scatter symbols, the player tends to have a relatively high difficulty in grasping the meaning of the payout, that is, the number and type of scatter symbols which generate the payout.

This configuration has caused the problem that the player feels that games are dryasdust games in which the number of credits only increases or decreases while the player is not being aware of that.

In light of the aforementioned problem, the present invention has been devised, and an object of the present invention is to provide a slot machine which rearranges scatter symbols, the slot machine and a game control method which can prevent players from feeling that games are dryasdust games.

The contents of U.S. Pat. No. 6,960,133, U.S. Pat. No. 6,012,983 U.S. Pat. No. 6,093,102, U.S. Pat. No. 6,604,999 and US 2002-0065124-A1 are incorporated herein by reference in their entirety.

### SUMMARY OF THE INVENTION

The present invention provides a slot machine having the following configuration.

That is, the slot machine comprises a display and a controller.

The display is capable of rearranging a plurality of colored symbols or a plurality of symbols each having a colored background. The controller is programmed to execute the following processing of:

(A) rearranging the plurality of symbols to the display;

(B) determining an amount of a normal payout, based on the numbers of symbols of respective types rearranged in the processing (A);

(C) determining an additional payout condition relating to colors;

(D) determining an amount of an additional payout, based on at least the colors of the symbols rearranged in the processing (A) or at least the colors of the backgrounds of the symbols, and the additional payout condition determined in the processing (C); and

(E) paying out game media corresponding to the amount of the normal payout determined in the processing (B) and game media corresponding to the amount of the additional payout determined in the processing (D).

In the aforementioned slot machine, the symbols which are rearranged to the display are symbols each having a color on themselves or symbols each having a color on the background. After symbols are rearranged to the display, the amount of the normal payout is determined, based on the numbers of rearranged symbols of respective types. That is, the amount of the normal payout is determined, based on the numbers of symbols of the respective types, not based on a combination of symbols established along a winning line. The aforementioned symbols are so-called scatter symbols.

On the other hand, the slot machine determines the additional payout condition relating to colors. Then, the amount of the additional payout is determined, based on at least the colors of symbols rearranged to the display or at least the colors of the backgrounds of the symbols, and the determined additional payout condition. That is, the amount of additional payout is determined based on the colors of the rearranged symbols or the backgrounds of the symbols.

As described above, the aforementioned slot machine is configured to determine the amount of the additional payout, based on the colors which are elements visually recognizable by humans. This configuration enables the player to grasp relatively easily the meaning of the payout of game media corresponding to the amount of the additional payout (hereinafter, also referred to as the additional payout), namely which color of the rearranged symbols or the backgrounds of the symbols causes the additional payout. Therefore, it is possible to prevent the player to feel that games are dryasdust games in which the number of credits only increases or decreases while the player is not aware of that, due to the difficulty in grasping the meaning of the payouts.

Further, the amount of the additional payout is determined based on the additional payout condition relating to colors and the colors of the rearranged symbols or the backgrounds of the symbols, so that it is possible to cause the player to have interests and regards for the color relating to the additional payout condition and the colors of the rearranged symbols or the backgrounds of the symbols. This configuration can cause the player to concentrate on these colors, thereby immersing the player in games, and can prevent the player from feeling that the games are dryasdust games.

Further, the slot machine of the present invention preferably has the following configuration.

That is, the processing (C) is processing for selecting a single color out of plural types of colors. Further, the processing (D) is processing for determining the amount of the additional payout based on the number of symbols colored the same as the color determined in the processing (C) or the number of symbols each having a background colored the same as the color, out of the symbols rearranged in the processing (A).

Thus, according to the aforementioned slot machine, the amount of the additional payout is determined, based on the number of symbols colored the same as the color determined as the additional payout condition or the number of symbols (hereinafter, also simply referred to as the symbols colored the same as the color determined as the additional payout condition etc.) each having the background colored the same as this color, out of the rearranged symbols. Accordingly, the number of such symbols is a matter of significant concern for the player. Therefore, it is possible to cause the player to have a great fun in counting the number of such symbols during games, resulting in further prevention of the player from feeling that games are dryasdust games.

Further, the slot machine of the present invention preferably has the following configuration.

That is the processing (C) is processing for selecting a single color out of plural types of colors, and also determining a number to be referred to when the amount of the additional payout is determined. Further the processing (D) is processing for determining the amount of the additional payout, when the number of symbols colored the same as the color determined in the processing (C) or the number of symbols having a background colored the same as the color, out of the symbols rearranged in the processing (A), is equal to or more than the number determined in the processing (C).

As described above, according to the aforementioned slot machine, when the number of symbols and the like colored the same as the color determined as the additional payout condition is equal to or more than the number determined as the additional payout condition, the additional payout is conducted. On the contrary, when the number of symbols and the like colored the same as the color determined as the additional payout condition is less than the number determined as the additional payout condition, no additional payout is conducted. This configuration can please the player, when the number of symbols is equal to or more than this number. On the contrary, this configuration can disappoint the player, when the number of symbols is less than this number. As described above, it is possible to cause the player to experience emotional ups and downs, thereby further preventing the player from feeling that the games are dryasdust games.

Further, the slot machine of the present invention preferably has the following configuration.

That is the processing (C) comprises processing of: (C-1) varying and displaying a plurality of special symbols each having a different candidate condition displayed thereon to the display and then stop-displaying a single special symbol to the display, and (C-2) determining the candidate condition displayed on the special symbol stop-displayed in the processing (C-1) as the additional payout condition.

As described above, according to the aforementioned slot machine, a plurality of special symbols are varied and displayed to the display. On each of the special symbols, a different candidate condition is displayed. When a single special symbol is stop-displayed, the candidate condition displayed on the stop-displayed special symbol is determined as the additional payout condition to be referred to when the additional payout is determined.

The amount of the additional payout depends on the candidate condition displayed on the stop-displayed special symbol. Accordingly, which special symbol is stop-displayed is a matter of significant concern for the player.

Accordingly, it is possible to cause the player to have a sense of expectancy for which special symbol is stop-displayed, thereby immersing the player in games.

The present invention provides a controlling method of a slot machine having the following configuration.

That is the aforementioned controlling method of a slot machine comprises the steps of: (A) rearranging a plurality of colored symbols or a plurality of symbols each having a colored background; (B) determining an amount of a normal payout, based on the numbers of symbols of respective types rearranged in the step (A); (C) determining an additional payout condition relating to colors; (D) determining an amount of an additional payout based on at least the colors of the symbols rearranged in the step (A) or at least the colors of the backgrounds of the symbols, and the additional payout condition determined in the step (C); and (E) paying out game media corresponding to the amount of the normal payout determined in the step (B) and game media corresponding to the amount of the additional payout determined in the step (D).

In the aforementioned controlling method of a slot machine, the symbols which are rearranged to the display are symbols each having a color on themselves or symbols each having a color on the background. After symbols are rearranged to the display, the amount of the normal payout is determined, based on the numbers of rearranged symbols of respective types. That is, the amount of the normal payout is determined, based on the numbers of symbols of the respective types, not based on a combination of symbols established along a winning line. The aforementioned symbols are so-called scatter symbols.

On the other hand, in the aforementioned controlling method of a slot machine, the slot machine determines the additional payout condition relating to colors. Then, the amount of the additional payout is determined, based on at least the colors of symbols rearranged to the display or at least the colors of the backgrounds of the symbols, and the determined additional payout condition. That is, the amount of additional payout is determined based on the colors of the rearranged symbols or the backgrounds of the symbols.

As described above, the aforementioned controlling method of a slot machine is configured to determine the amount of the additional payout, based on the colors which are elements visually recognizable by humans. This configuration enables the player to grasp relatively easily the meaning of the payout of game media corresponding to the amount of the additional payout (hereinafter, also referred to as the additional payout), namely which color of the rearranged symbols or the backgrounds of the symbols causes the additional payout. Therefore, it is possible to prevent the player to feel that games are dryasdust games in which the number of credits only increases or decreases while the player is not aware of that, due to the difficulty in grasping the meaning of the payouts.

Further, the amount of the additional payout is determined based on the additional payout condition relating to colors and the colors of the rearranged symbols or the backgrounds of the symbols, so that it is possible to cause the player to have interests and regards for the color relating to the additional payout condition and the colors of the rearranged symbols or the backgrounds of the symbols. This configuration can cause the player to concentrate on these colors, thereby immersing the player in games, and can prevent the player from feeling that the games are dryasdust games.

### BRIEF DESCRIPTIONS OF DRAWINGS

FIG. 1A is a view illustrating an exemplary symbol matrix according to a first embodiment.

FIG. 1B is another view illustrating an exemplary symbol matrix according to the first embodiment.

FIG. 1C is another view illustrating an exemplary symbol matrix according to the first embodiment.

FIG. 1D is a view illustrating special symbols according to the first embodiment.

FIG. 2 is a view illustrating the relationships between special symbols and additional payouts according to the first embodiment.

FIG. 3 is a perspective view illustrating the external appearance of a slot machine.

FIG. 4 is a block diagram illustrating an internal configuration of the slot machine illustrated in FIG. 3.

FIG. 5 is a flowchart illustrating a subroutine of slot machine game execution processing.

FIG. 6 is a view illustrating the relationships between the numbers of BETs and types of symbols to be made effective.

FIGS. 7A to 7C are views each illustrating an exemplary image which is displayed to an upper image display panel.

FIG. 8 is a view illustrating the relationships between the numbers of rearranged symbols and amounts of normal payouts.

FIG. 9 is a flowchart illustrating a subroutine of amount-of-additional-payout determination processing according to the first embodiment.

FIG. 10 is a flowchart illustrating a subroutine of free-game execution processing.

FIG. 11A is a view illustrating an exemplary symbol matrix according to a second embodiment.

FIG. 11B is a view illustrating a special symbol matrix according to the second embodiment.

FIG. 12 is a view illustrating the relationships between special symbols and additional payouts according to the second embodiment.

FIG. 13 is a view illustrating a subroutine of amount-of-additional-payout determination processing according to the second embodiment.

FIG. 14 is a perspective view illustrating an external appearance of a slot machine according to another embodiment.

### DESCRIPTION OF THE EMBODIMENTS

### First Embodiment

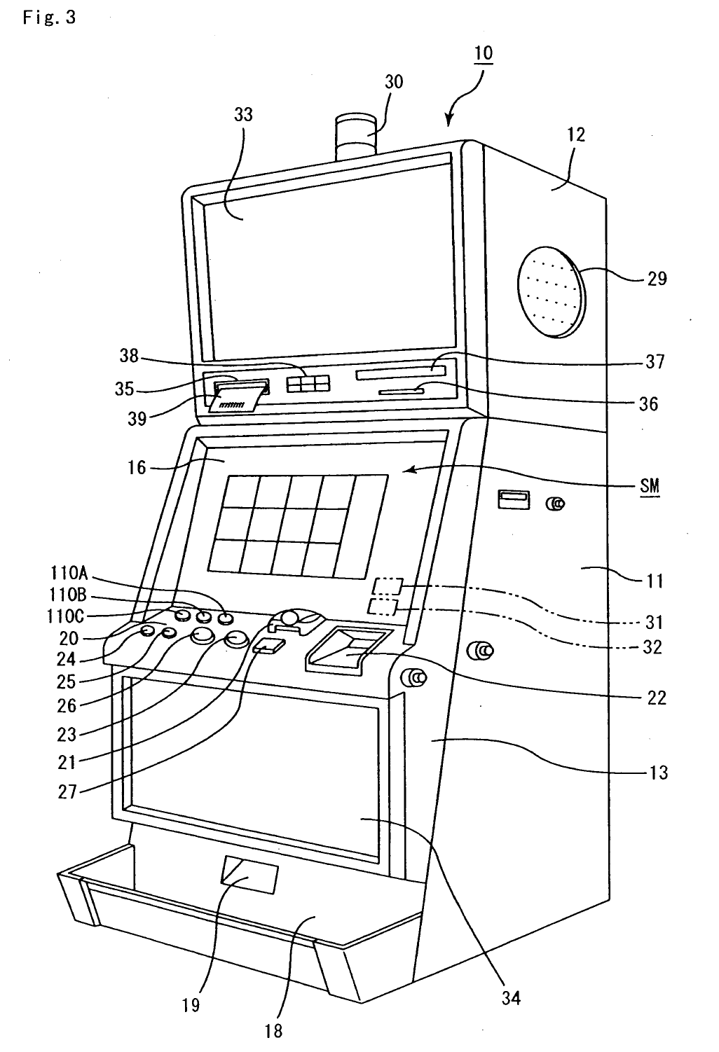

In a slot machine 10 (see FIG. 3) according to a first embodiment, a special symbol is stop-displayed, after rearrangement of symbols. Then, based on the result of the rearranged symbols, an amount of a normal payout is determined. Further, based on the result of the rearranged symbols and the result of the stop-displayed special symbol, an amount of an additional payout is determined. Subsequently, game media such as coins corresponding to the total sum of the amount of the normal payout and the amount of the additional payout are paid out.

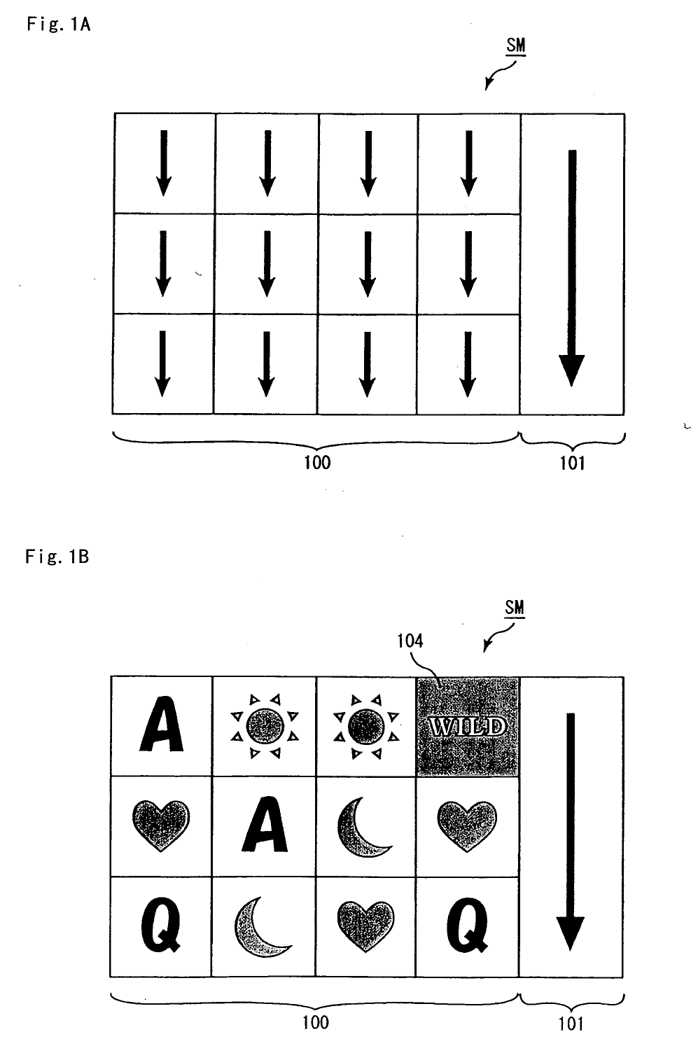

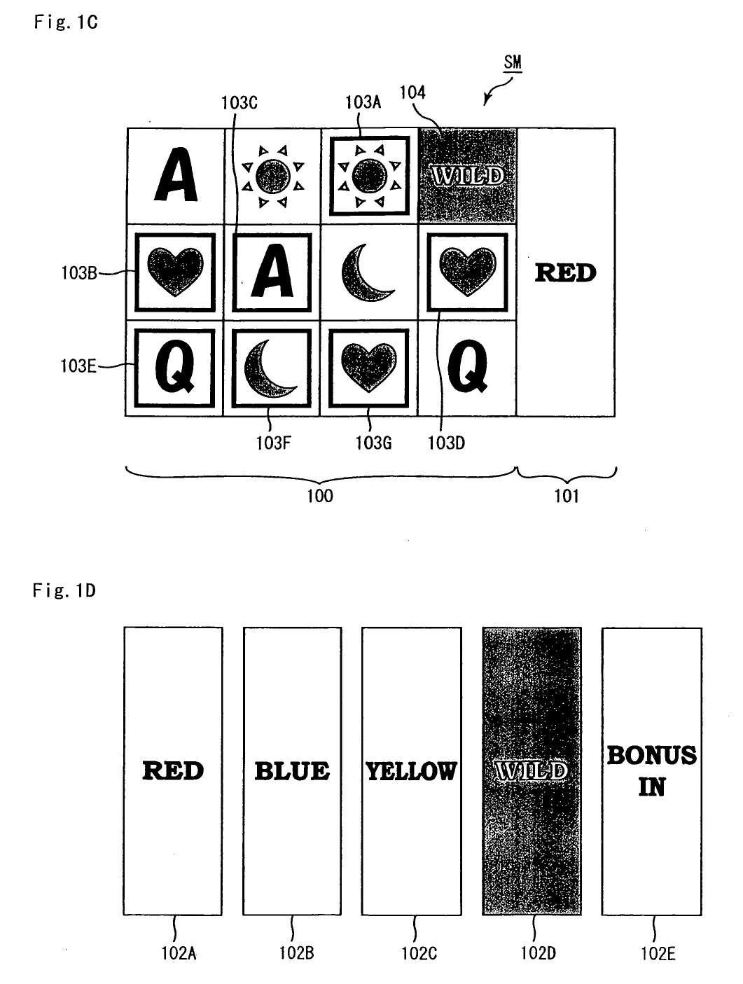

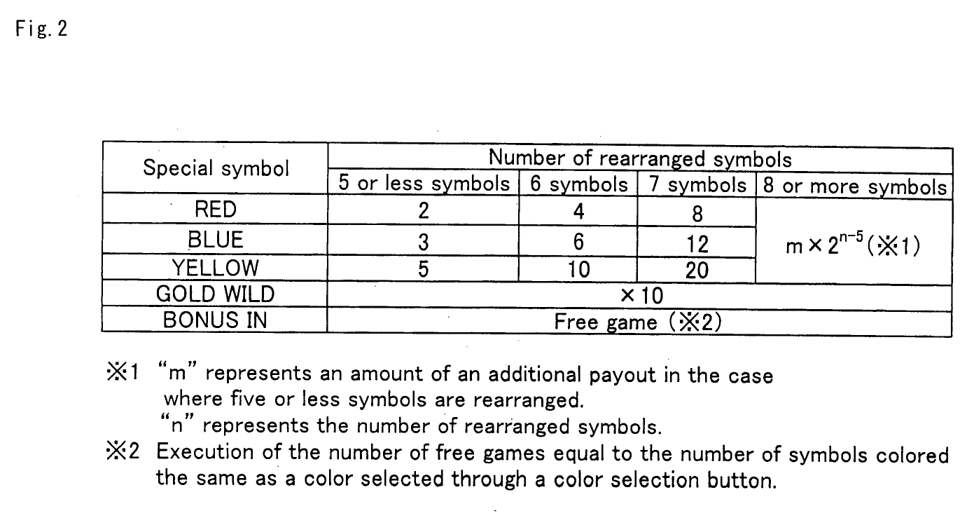

Hereinafter, with reference to FIGS. 1 and FIG. 2, the outline of the first embodiment will be described.

FIGS. 1A to 1C are views each illustrating an exemplary symbol matrix. FIG. 1D is a view illustrating special symbols according to the first embodiment.

FIG. 2 is a view illustrating the relationships between the special symbols and the additional payouts according to the first embodiment.

Each symbol matrix SM illustrated in FIGS. 1A to 1C is the symbol matrix SM displayed to a lower image display panel 16 (the display of the present invention) provided in the slot machine 10 (see FIG. 3). The symbol matrix SM is constituted by a symbol display area 100 and a special-symbol display area 101. The symbol display area 100 is capable of displaying a total of 12 symbols along 3 rows and 4 columns. The special-symbol display area 101 is capable of displaying a single special symbol.

When a player presses a start button 23 (see FIG. 3) provided in the slot machine 10, scrolling of symbols starts in the symbol display area 100, as illustrated in FIG. 1A, and scrolling of special symbols also starts in the special-symbol display area 101 (the varying and displaying of the present invention).

Thereafter, as illustrated in FIG. 1B, symbols are rearranged in the symbol display area 100. As described above, the amount of the normal payout is determined, based on the result of the rearrangement.

In the first embodiment, there are 6 types of the symbols “Q”, “A”, “MOON”, “SUN”, “HEART” and “GOLD WILD”, as symbols which are displayed in the symbol display area 100. Further, all the symbols are constituted by so-called scatter symbols. More specifically, the amount of the normal payout is determined as follows.

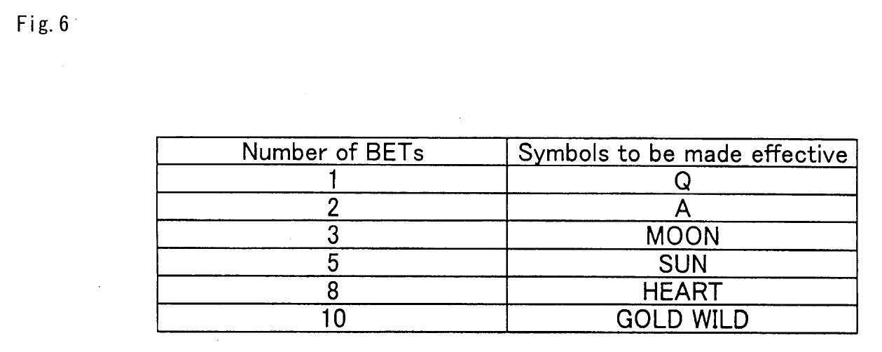

(i) When game media such as coins are BET in the slot machine 10, scatter symbols of a type corresponding to the number of BETs are made effective. For example, when the number of BETs is 1, “Q” is made effective and, when the number of BETs is 2, “A” is made effective (see FIG. 6).

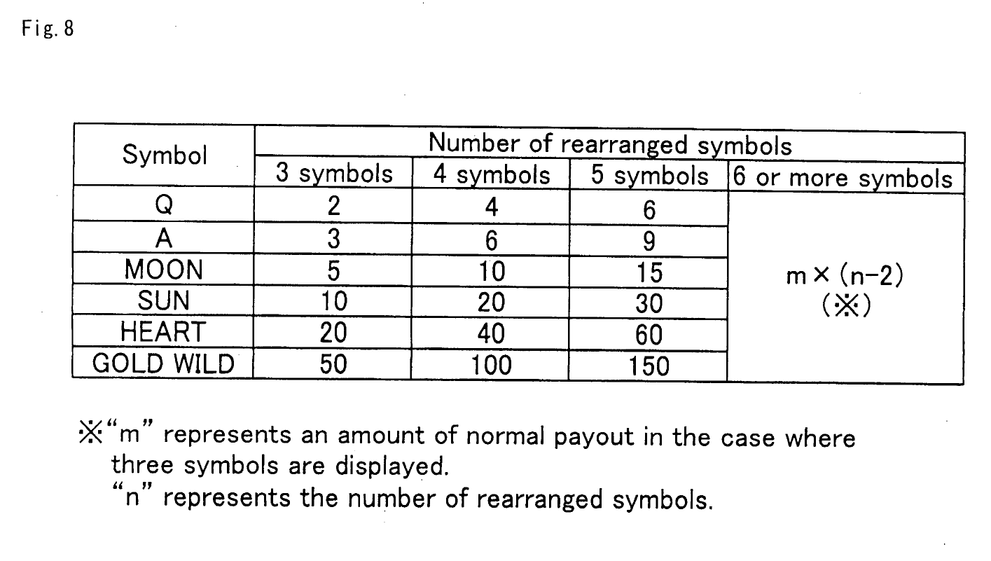

(ii) After rearrangement of the symbols in the symbol display area 100, the number of symbols of the effective type displayed in the symbol display area 100 is counted. Then, based on the counted number of symbols, the amount of the normal payout is determined. For example, when “HEART” has been made effective, when three “HEARTs” are rearranged as illustrated in FIG. 1B, the amount of the normal payout is an amount corresponding to 20 coins (see FIG. 8).

The amount of the normal payout has been described. Subsequently, the amount of the additional payout will be described.

As illustrated in FIG. 1B, when the symbols are rearranged in the symbol display area 100, a special symbol has not been stop-displayed yet and the special symbols are still being scroll-displayed in the special display area 101.

Thereafter, a special symbol is stop-displayed as illustrated in FIG. 1C.

FIG. 1C illustrates a state where a special symbol “RED” 102A (see FIG. 1D) is stop-displayed as a special symbol. Hereinafter, the amount of the additional payout will be described, by exemplifying a case where the special symbol “RED” 102A is stop-displayed.

(I) In the first embodiment, the respective symbols which are displayed in the symbol display area 100 have one of colors of red, blue and yellow.

(II) On the other hand, there is illustrated, in FIG. 1C, a state where characters describing “RED” are displayed on the specific symbol “RED” 102A, but these characters are illustrated for convenience of the description. In actual, the special symbol “RED” 102A has no character displayed thereon and has only a red color applied thereon.

(III) After the special symbol “RED” 102A is stop-displayed in the special-symbol display area 101, the number of symbols colored the same as the color “red” of the special symbol, out of the symbols rearranged in the symbol display area 100, is counted. Then, based on the number of counted symbols, an amount of the additional payout is determined.

For example, in the example illustrated in FIG. 1C, the symbols enclosed by a frame (red symbols 103A to 103G) represent symbols colored red. In this case, similarly, the symbols are illustrated as being enclosed by the frame for indicating which symbols are colored red for convenience of the description. However, in actual, the symbols are not displayed in such a way that they are enclosed by a frame. In actual, the symbols themselves have a color, so that a player can immediately recognize which symbols have the red color, without a frame for enclosing the symbols.

In the example illustrated in FIG. 1C, the symbols colored red are 7 of the red symbols 103A to 103G. In this case, the amount of the additional payout is an amount corresponding to 8 coins (see FIG. 2). Further, the amount of the additional payout is determined only when the amount of the normal payout is not 0.

While, in FIG. 1C, there is illustrated a state where the special symbol “RED” 102A is stop-displayed as the special symbol, the special symbols are not constituted by only the special symbol “RED” 102A.

As illustrated in FIG. 1D, the special symbols which may be stop-displayed in the special-symbol display area 101 also include a special symbol “BLUE” 102B, a special symbol “YELLOW” 102C, a special symbol “GOLD WILD” 102D, and a special symbol “BONUS IN” 102E.

While the special symbol “RED” 102A is colored red, the special symbol “BLUE” 102B is colored blue. Further, the special symbol “YELLOW” 102C is colored yellow. The special symbol “BLUE” 102B and the special symbol “YELLOW” 102C are the same as the special symbol “RED” 102A, except that they have a different color from each other.

When the special symbol “BLUE” 102B or the special symbol “YELLOW” 102C is stop-displayed in the special-symbol display area 101, the amount of the additional payout is determined according to almost the same method as that when the special symbol “RED” 102A is stop-displayed therein. Therefore, the method for determining the amount of the additional payout in such cases will not described herein.

The red color of the special symbol “RED” 102A, the blue color of the special symbol “BLUE” 102B and the yellow color of the special symbol “YELLOW” 102C correspond to the additional payout condition according to the present invention.

In the special symbol “GOLD WILD” 102D, characters describing “WILD” are displayed and also, the background (surrounding) of the characters is colored gold. When the special symbol “GOLD WILD” 102D is stop-displayed in the special-symbol display area 101, when there exists at least a single symbol “GOLD WILD” 104 (see FIG. 1C), in the symbols rearranged in the symbol display area 100, then game media such as coins corresponding to an amount of a payout which is ten times the amount of the normal payout are paid out, regardless of the number of the symbols “GOLD WILD” 104 (see FIG. 2). Namely, the amount of the payout which is nine times the amount of the normal payout is determined as an amount of the additional payout. In the symbols “GOLD WILD” 104, characters (symbols) describing “WILD” are displayed and also, the background of the characters is colored gold, similarly to the special symbol “GOLD WILD” 102D.

The gold color of the special symbol “GOLD WILD” 102D and the characters describing “WILD” which are displayed in the special symbol “GOLD WILD” 102D corresponds to the additional payout condition according to the present invention. The additional payout condition according to the present invention may include factors other than colors (for example, characters for identifying types of symbols), as described above.

For example, in the case where “A colored YELLOW” is determined as the additional payout condition, the amount of the additional payout may be determined, based on the number of symbols “A” colored yellow, out of the rearranged symbols.

Also, the amount of the additional payout according to the present invention may be determined, regardless of the number of symbols which correspond to the additional payout condition, out of the rearranged symbols, as the example of the special symbol “GOLD WILD” 102D.

In the special symbol “BONUS IN” 102E, characters describing “BONUS IN” are displayed, but the special symbol “BONUS IN” 102E has no specific color. When the special symbol “BONUS IN” 102E is stop-displayed in the special-symbol display area 101, free games are executed, in which the number of free games to be executed is determined according to a predetermined method (see FIG. 2). In free games, slot machine games are executed even if no game media are BET. The number of free games is determined as follows.

In the slot machine 10, there are provided a red selection button 110A, a blue selection button 110B and a yellow selection button 110C (see FIG. 3). These three buttons will be comprehensively referred to as color selection buttons 110, hereinafter. The player can select one of the colors by pressing any one of the color selection buttons 110.

When the special symbol “BONUS IN” 102E is stop-displayed in the special-symbol display area 101, then the number of symbols colored the same as the color selected through the color selection buttons 110, out of the symbols rearranged in the symbol display area 100, is counted. Then, the counted number of symbols is determined as the number of free games, and the number of free games equal to the determined number of free games are executed.

As described above, when the special symbol stop-displayed in the special-symbol display area 101 is the special symbol “RED” 102A, the special symbol “BLUE” 102B, the special symbol “YELLOW” 102C or the special symbol “GOLD WILD” 102D, then game media corresponding to the total sum of the amount of the normal payout and the amount of the additional payout are paid out. On the other hand, when the special symbol stop-displayed in the special-symbol display area 101 is the special symbol “BONUS IN” 102E, then free games are executed. In the present specification, both of the payout of game media corresponding to an amount of the additional payout and the execution of free games refers to “conduct the additional payout”.

There has been described the outline of the first embodiment, with reference to FIGS. 1A to 1D and FIG. 2.

Hereinafter, the first embodiment will be described in more detail.

FIG. 3 is a perspective view illustrating the external appearance of the slot machine.

In the slot machine 10, a coin, a bill, or electronic valuable information corresponding thereto is used as a game medium. However, in the present invention, a game medium is not particularly limited. Examples of the game medium may include a medal, a token, electronic money, or a ticket. It should be noted that the ticket is not particularly limited, and examples thereof include a ticket with a bar code, which will be described later.

A slot machine 10 is a standalone type slot machine that is not connected to a network, but the present invention can also be applied to a slot machine connected to a network.

The slot machine 10 includes: a cabinet 11; a top box 12 placed on the upper side of the cabinet 11; and a main door 13 provided at the front face of the cabinet 11. The lower image display panel 16 is provided in front of the main door 13. The lower image display panel 16 includes a liquid crystal display panel which displays the symbol matrix SM (see FIG. 1) constituted by the symbol display area 100 and the special-symbol display area 110. The lower image display panel 16 corresponds to the display of the present invention. In the lower image display panel 16, there are provided a number-of-credits display section 31 and a number-of-payouts display section 32 (not shown).

The number-of-credits display section 31 displays an image indicating the number of credited coins. The number-of-payouts display section 32 displays an image indicating the number of coins as a payout.

Further, a touch panel 69, which is not shown in the figure, is provided on the front face of the lower image display panel 16 and the player can input various kinds of commands by operating the touch panel 69.

Below the lower image display panel 16, there are provided a control panel 20 comprised of a plurality of buttons 23 to 27 and 110 (110A, 110B and 110C) with each of which a command according to the game progress is inputted by the player, a coin receiving slot 21 through which a coin is accepted into the cabinet 11, and a bill validator 22.

The control panel 20 is provided with a start button 23, a change button 24, a CASHOUT button 25, a 1-BET button 26, and a maximum BET button 27. The start button 23 is used for inputting a command to start a game. The change button 24 is used for making a request of staff at a recreation facility for exchange. The CASHOUT button 25 is used for inputting a command to pay out credited coins to a coin tray 18.

The 1-BET button 26 is used for inputting a command to BET one coin on a game out of credited coins. The maximum BET button 27 is used for inputting a command to BET the maximum number (10 in the present embodiment) of coins that can be bet on a single game out of credited coins.

Further, in the control panel 20, there are provided the red selection button 110A, the blue selection button 110B and the yellow selection button 110C. As described above, the player can select one of the red, blue and yellow colors by pressing one of the color selection buttons 110. Then, when the special symbol “BONUS IN” 102E (see FIG. 1D) is stop-displayed in the special-symbol display area 101, the number of free games is determined, based on the number of symbols colored the same as the color selected through the color selection buttons 110, out of the symbols rearranged in the symbol display area 100.

The bill validator 22 not only discriminates a regular bill from a false bill, but also accepts the regular bill into the cabinet 11. It should be noted that the bill validator 22 may be configured so as to be capable of reading a later-described ticket 39 with a barcode. At the lower front face of the main door 13, namely below the control panel 20, there is provided a belly glass 34 on which a character or the like of the slot machine 10 is drawn.

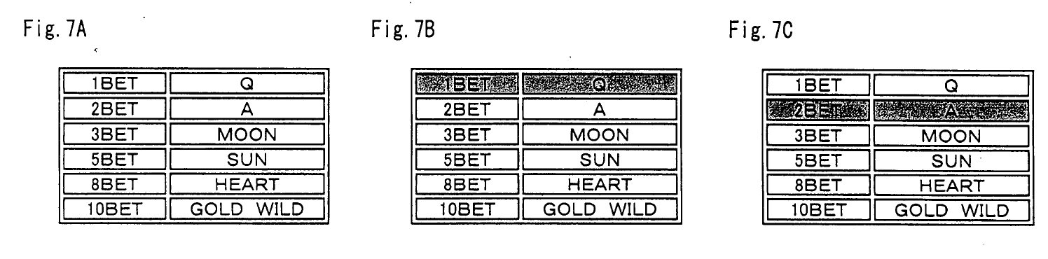

At the front face of the top box 12, an upper image display panel 33 is provided. The upper image display panel 33 is provided with a liquid crystal panel to display, for example, an image representing an introduction of the contents of a game or a description of a rule of the game. Further, the upper image display panel 33 displays an image indicative of the type of symbols which has been made effective according to the number of BETs (see FIGS. 7(A) to (C)).

Further, the top box 12 is provided with a speaker 29. Below the upper image display panel 33, there are provided a ticket printer 35, a card reader 36, a data display 37, and a keypad 38. The ticket printer 35 prints on a ticket a barcode as coded data of the number of credits, date and time, an identification number of the slot machine 10, and the like, and outputs the ticket as a ticket 39 with a barcode. The player can make another slot machine read the ticket 39 with a barcode to play a game thereon, or can exchange the ticket 39 with a barcode with bills or the like at a predetermined place in the recreation facility (e.g., a cashier in a casino).

The card reader 36 reads data from a smart card and writes data into the smart card. The smart card is a card owned by the player, and for example, data for identifying a player and data on a history of games played by the player are stored therein. Data corresponding to a coin, a bill, or a credit may be stored in the smart card. Further, in place of the smart card, a magnetic stripe card may be adopted. The data display 37 is comprised of a fluorescent display or the like, and displays, for example, data read by the card reader 36 or data inputted by the player through the keypad 38. The keypad 38 is used for inputting a command and data concerning the issue of a ticket and the like.

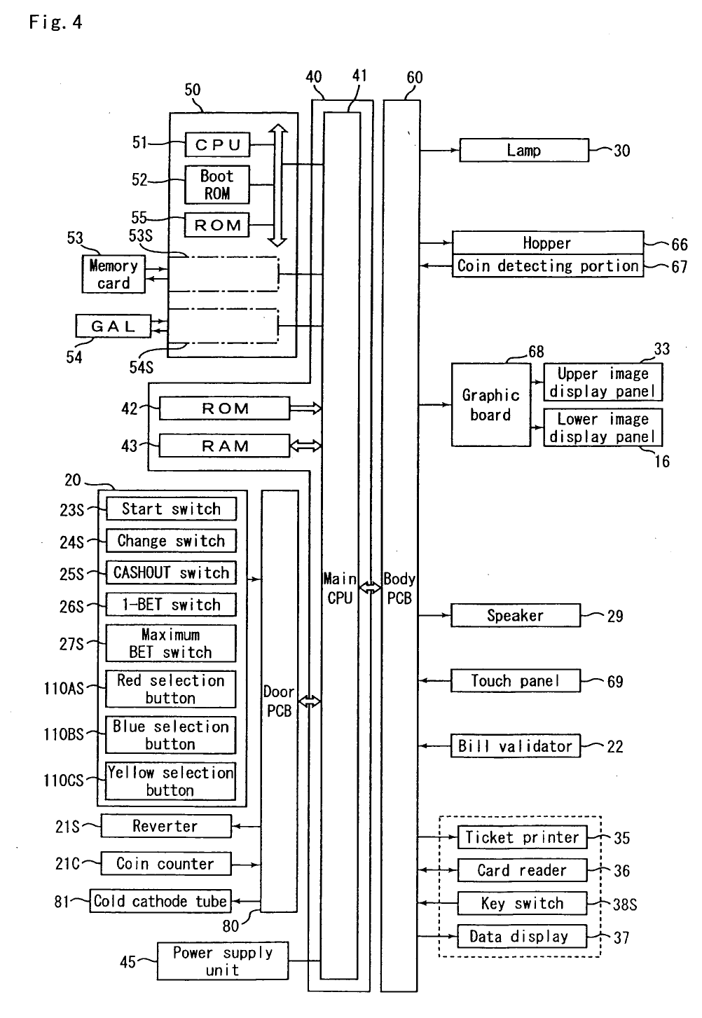

FIG. 4 is a block diagram showing an internal configuration of the slot machine shown in FIG. 3.

A gaming board 50 includes a CPU (Central Processing Unit) 51, a ROM 55, and a boot ROM 52 which are interconnected to one another via an internal bus, a card slot 53S corresponding to a memory card 53, and an IC socket 54S corresponding to a GAL (Generic Array Logic) 54.

The memory card 53 is formed from a nonvolatile memory such as CompactFlash (registered trademark) and stores game programs and game system programs. The game programs include a symbol selection program. The aforementioned symbol selection program is a program for determining the symbols to be rearranged in the symbol display area 100 and the special symbol to be stop-displayed in the special-symbol display area 101. The aforementioned symbol selection program includes symbol weighing data in association with plural types of payout ratios (for example, 80%, 84%, 88%). The symbol weighing data is data indicating the correspondence between the respective symbols and the respective special symbols, and one or more random numbers which fall in a predetermined numerical range (0 to 255). The payout ratios are determined based on payout-ratio setting data outputted from the GAL 54 and, based on the symbol weighing data associated with the payout ratios, the symbols to be rearranged in the symbol matrix are determined.

Further, the game programs include table data (see FIG. 8) indicative of the relationships between the numbers of rearranged symbols and the amounts of normal payouts. Furthermore, the game programs include table data (see FIG. 2) indicative of the relationships between the special symbols and additional payouts.

Further, the card slot 53S is configured so as to allow the memory card 53 to be inserted thereinto or ejected therefrom, and is connected to a mother board 40 via an IDE bus. Thus, the memory card 53 can be ejected from the card slot 53S, and then another game program is written onto the memory card 53, and the memory card 53 can be inserted into the card slot 53S, to change the type and contents of a game to be played on the slot machine 10. The game program includes a program associated with the progress of a game. The game program also includes image data and sound data to be outputted during the game. The image data includes image data and the like indicating a symbol matrix.

The GAL 54 is a type of PLD having a fixed OR array structure. The GAL 54 includes plural input ports and plural output ports and, when predetermined data is inputted to an input port, the GAL 54 outputs data corresponding to the aforementioned data from an output port. The data outputted from this output port is the aforementioned payout-ratio setting data.

Further, the IC socket 54S is configured to allow the GAL 54 to be attached thereto and detached therefrom and is connected to the mother board 40 through a PCI bus. Accordingly, the GAL 54 can be replaced with another GAL 54 to change the payout-ratio setting data.

CPU 51, ROM 55 and boot ROM 52 interconnected to one another via an internal bus are connected to the mother board 40 by PCI bus.

The mother board 40 is constructed with a general-purpose mother board commercially available (a printed circuit board on which basic parts of a personal computer are mounted) and includes a main CPU 41, ROM (Read Only Memory) 42 and RAM (Random Access Memory) 43. The mother board 40 is the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is an initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41. RAM 43 can also store the game program. RAM 43 further stores data on the number of credits, the number of coins-in or coins-out for one game, and the like.

Further, in the RAM 43, there are provided a color storage area and a number-of-free-games storage area.

The color storage area stores data indicative of the color selected through the color selection buttons 110. The number-of-free-games storage area stores data indicative of the number of remaining free games to be generated in the event that the special symbol “BONUS IN” is stop-displayed.

To the mother board 40, a body PCB (Printed Circuit Board) 60 and a door PCB 80, which will be described later, are connected through respective USBs. Further, the mother board 40 is connected with a power supply unit 45.

The body PCB 60 and the door PCB 80 are connected with equipment and devices that generate input signals to be inputted to the main CPU 41, and equipment and devices operations of which are controlled by control signals outputted from the main CPU 41. The main CPU 41 executes a game program stored in the RAM 43 based on an input signal inputted to the main CPU 41, thereby executes the predetermined arithmetic processing and stores a result thereof in the RAM 43, or transmits a control signal to each of the equipment and devices as processing for controlling each of the equipment and devices.

To the body PCB 60, there are connected a lamp 30, a hopper 66, a coin detecting portion 67, a graphic board 68, a speaker 29, a touch panel 69, a bill validator 22, a ticket printer 35, a card reader 36, a key switch 38S, and a data display 37. The lamp 30 lights up in a predetermined pattern based on a control signal outputted from the main CPU 41.

The hopper 66 is installed inside the cabinet 11 and pays out a predetermined number of coins from the coin payout exit 19 to the coin tray 18, based on a control signal outputted from the main CPU 41. The coin detecting portion 67 is provided inside the coin payout exit 19, and outputs an input signal to the main CPU 41 when detecting a payout of a predetermined number of coins from the coin payout exit 19.

The graphic board 68 controls, based on a control signal outputted from the main CPU 41, an image display to the upper image display panel 33 and the lower image display panel 16. The number of credits stored in RAM 43 is displayed to the number-of-credits display section 31 (not shown) of the lower image display panel 16. The number of coins-out is displayed to the number-of-payouts display section 31 (not shown) of the lower image display panel 16. The graphic board 68 is equipped with VDP (Video Display Processor) which generates image data based on a control signal outputted from the main CPU 41 and a video RAM which temporarily stores image data generated by VDP, and of the like equipments. It should be noted that image data used in generating image data with VDP is contained in a game program read from the memory card 53 and stored in RAM 43.

The bill validator 22 not only discriminates a regular bill from a false bill, but also accepts the regular bill into the cabinet 11. When accepting a regular bill, the bill validator 22 outputs an input signal to the main CPU 41, based on the face amount of the bill. The main CPU 41 stores, in the RAM 43, the number of credits according to the face amount of the bill transmitted with the input signal.

The ticket printer 35 prints on a ticket, based on a control signal outputted from the main CPU 41, a barcode formed by encoding data such as the number of credits, date and time, an identification number of the slot machine 10, and of the like data stored in the RAM 43, and outputs the ticket as a ticket 39 with a barcode.

The card reader 36 reads data from a smart card and transmits the data to the main CPU 41 or writes data into the smart card based on a control signal from the main CPU 41. The key switch 38S is provided on the keypad 38, and outputs a predetermined input signal to the main CPU 41 when the keypad 38 is operated by the player. The data display 37 displays, based on a control signal outputted from the main CPU 41, data read by the card reader 36 or data inputted by the player through the keypad 38.

To the door PCB 80, there are connected a control panel 20, a reverter 21S, a coin counter 21C, and a cold cathode tube 81. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. Each of the switches 23S to 27S outputs an input signal to the main CPU 41 when each of the buttons 23 to 27 corresponding thereto is operated by the player.

Further, in the control panel 20, there are provided a red selection switch 110AS corresponding to the red selection button A, a blue selection switch 110BS corresponding to the blue selection button 110B, and a yellow selection switch 110CS corresponding to the yellow selection button 110C. Each of the switches 110AS to 110CS outputs an input signal to the main CPU 41, when each of the buttons 110A to 110C corresponding thereto is operated by the player.

The coin counter 21C is provided inside the coin receiving slot 21 and discriminates a regular coin from a false coin inserted into the coin receiving slot 21 by the player. Coins other than regular coins are discharged from the coin payout exit 19. When the coin counter 21C detects a regular coin, the coin counter 21C outputs an input signal to the main CPU 41.

The reverter 21S operates based on a control signal outputted from the main CPU 41, and distributes a coin identified by the coin counter 21C as a regular coin into a cash box (not shown) or the hopper 66, which are disposed in the slot machine 10. Specifically, when the hopper 66 is filled with coins, a regular coin is distributed into the cash box by the reverter 21S. On the other hand, when the hopper 66 is not filled with coins, the regular coin is distributed into the hopper 66. The cold cathode tube 81 functions as a backlight installed on the rear face side of the lower image display panel 16 and the upper image display panel 33, and lights up based on a control signal to be outputted from the main CPU 41.

Next, processing executed on the slot machine 10 will be described.

The main CPU 41 reads a game program and executes the game program to progress a game.

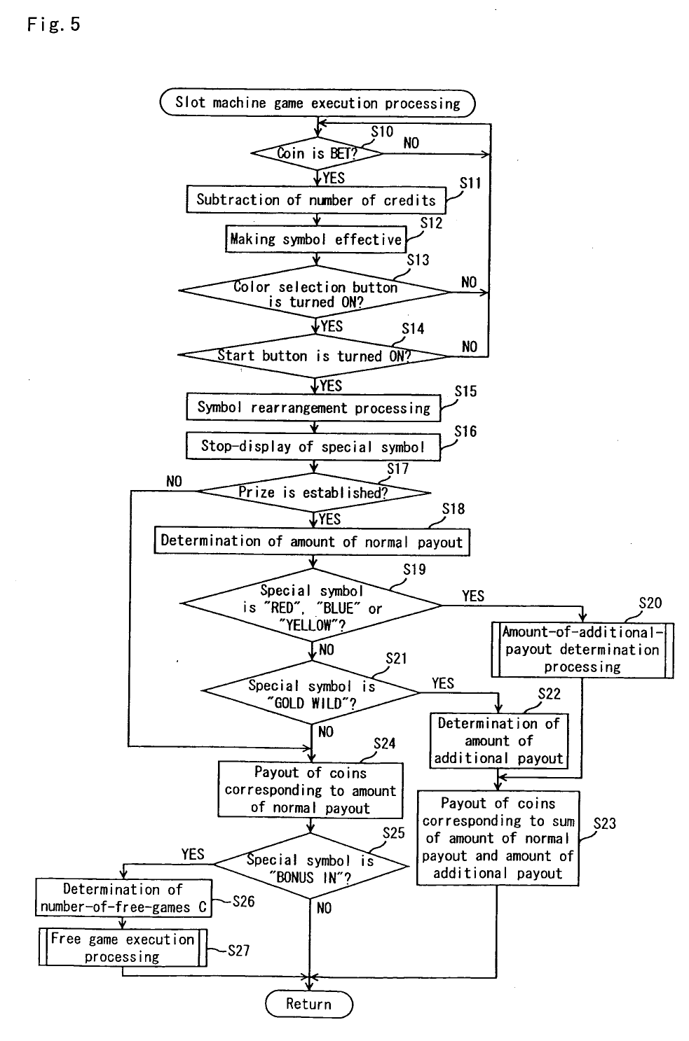

FIG. 5 is a flowchart showing a subroutine of slot machine game execution processing.

In the slot machine game execution processing, first, the main CPU 41 determines whether or not a coin has been BET (step S10). In the processing, the main CPU 41 determines whether or not to have received an input signal outputted from the 1-BET switch 26S when the 1-BET button 26 is operated or an input signal outputted from the maximum BET switch 27S when the maximum BET button 27 is operated. When determining that a coin has not been BET, the main CPU 41 returns the processing to step S10.

On the other hand, when determining that a coin has been BET in step S10, the main CPU 41 executes processing for making a subtraction from the number of credits stored in the RAM 43, according to the number of BET coins (step S11). It should be noted that, when the number of BET coins is larger than the number of credits stored in the RAM 43, the main CPU 41 does not execute the processing for making a subtraction from the number of credits stored in the RAM 43, and returns the processing to step S10. When the number of BET coins exceeds an upper limit of the number of coins that can be BET on a single game (10 in the present embodiment), the main CPU 41 does not execute the processing for making a subtraction from the number of credits stored in the RAM 43, and the processing is proceeded to step S12.

Next, the main CPU 41 makes the symbols effective according to the type corresponding to the number of BETS, and also displays to the upper image display panel 33 an image indicative of the symbols which have been made effective (step S12).

FIG. 6 is a view illustrating the relationships between the numbers of BETs and types of symbols.

As illustrated in FIG. 6, the types of symbols to be made effective are defined in association with the numbers of BETs. For example, “Q” is defined in association with the number of BETs of 1, and “A” is defined in association with the number of BETs of 2. In step S12, for example, the main CPU 41 makes “Q” effective when a single coin has been BET and makes “A” effective when 2 coins have been BET.

FIGS. 7(A) to (C) are views each illustrating an exemplary image which is displayed to the upper image display panel.

FIG. 7(A) illustrates an image which is displayed to the upper image display panel 33 at a state where no coin has been BET, and the image illustrates that different symbols are to be made effective according to the number of BETs.

FIG. 7(B) illustrates an image which is displayed to the upper image display panel 33 at a state where a single coin has been BET, and the image illustrates that “1BET” and “Q” are displayed in such a way that they are distinguishable from the others. More specifically, the portions at which “1BET” and “Q” are displayed have a background colored differently from that of the others.

FIG. 7(C) illustrates an image which is displayed to the upper image display panel 33 at a state where 2 coins have been BET, and the image illustrates that “2BET” and “A” are displayed in such a way that they are distinguishable from the others. More specifically, the portions at which “2BET” and “A” are displayed have a background colored differently from that of the other portions.

Although, in the present embodiment, there has been described a case where the upper image display panel 33 displays an image indicative of the symbol which has been made effective, in the present invention, the symbol which has been made effective may be indicated in such a manner that a table indicative of the correspondence between the numbers of BETs and symbols to be made effective is provided with a corresponding portion of the table illuminated with a back light.

In the aforementioned example, there has been described a case where a single type of symbols is made effective according to the number of BETs. However, the present invention is not limited thereto, and the number of types of symbols to be made effective may be increased with an increase in the number of BETs. For example, when the number of BETs is 1, “Q” is made effective, and when the number of BETs is 2, both “Q” and “A” are made effective. In the case of increasing the number of types of symbols to be made effective with increasing of the number of BETs, the total sum of amounts of payouts for the respective types of symbols can be determined as an amount of the normal award. For example, when three “Q”s and four “A”s are rearranged in the symbol display area 100 at the time of rearrangement of symbols, the total sum (8 coins) of an amount of a payout (2 coins) corresponding to three “Q”s and an amount of a payout (6 coins) corresponding to four “A”s can be determined as the amount of the normal payout.

Next, the main CPU 41 determines whether or not any of the color selection buttons 110 has been turned on (step S13). In this processing, the main CPU 41 determines whether or not it has received an input signal outputted from the red selection switch 110AS when the red selection button 110A is pressed, an input signal outputted from the blue selection switch 110BS when the blue selection button 110B is pressed, or an input signal outputted from the yellow selection switch 110CS when the yellow selection button 110C is pressed.

When the main CPU 41 determines that any of the color selection buttons 110 has not been turned on, the main CPU 41 returns the processing to step S10.

Further, when any of the color selection buttons 110 has not been turned on (for example, when a command for ending games is inputted without turning on any of the color selection buttons 110), the main CPU 41 cancels the result of the subtraction in step S11.

On the other hand, when the main CPU 41 determines that any of the color selection buttons 110 has been turned on, the main CPU 41 stores color data indicative of the type of the color selected through the color selection buttons 110 in a predetermined area of the RAM 43 (the color storage area) Then, the main CPU 41 shifts the processing to step S14.

In step S14, the main CPU 41 determines whether or not the start button 23 has been turned on. In the processing, the main CPU 41 determines whether or not to have received an input signal outputted from the start switch 23S when the start button 23 is pressed.

When determining that the start button 23 has not been turned ON, the main CPU 41 returns the processing to step S10. It should be noted that, when the start button 23 is not turned ON (for example, when a command to end the game is inputted without pressing the start button 23), the main CPU 41 cancels a result of the subtraction obtained in step S11.

On the other hand, when determining in step S14 that the start button 23 has been turned ON, then the main CPU 41 executes symbol rearrangement processing (step S15).

In this processing, at first, the main CPU 41 starts scroll-displaying of symbols in the symbol display area 100 and also starts scroll-displaying of special symbols in the special-symbol display area 101, as illustrated in FIG. 1A. Then, the main CPU 41 executes the aforementioned symbol selection program to determine symbols to be rearranged and then rearranges the symbols in the symbol display area 100.

When the main CPU 41, the ROM 42 and the RAM 43 execute the processing in step S15 in cooperation with one another, the main CPU 41, the ROM 42 and the RAM 43 function as the controller for executing processing (A) of the present invention. Here, step S15 corresponds to step (A) of the present invention.

Next, the main CPU 41 stop-displays a special symbol (step S16). In this processing, the main CPU 41 selects a single special symbol, out of the aforementioned five types of special symbols (“RED”, “BLUE”, “YELLOW”, “GOLD WILD” and “BONUS IN”), and then stop-displays the selected special symbol in the special-symbol display area 101.

When the main CPU 41, the ROM 42 and the RAM 43 execute the processing in step S16 in cooperation with one another, the main CPU 41, the ROM 42 and the RAM 43 function as the controller for executing the processing (C) of the present invention. Here, step S16 corresponds to step (C) of the present invention.

In the first embodiment, a special symbol is stop-displayed, after symbols are rearranged. However, in the present invention, the additional payout condition relating to colors may be determined, before symbols are rearranged.

Next, the main CPU 41 determines whether or not a prize has been established (step S17). In this case, establishment of a prize refers to rearrangement of 3 or more symbols of at least one type of the symbols of “Q”, “A”, “MOON”, “SUN”, “HEART” and “GOLD WILD”, in the symbol display area 100 (see FIG. 8). In this processing, the main CPU 41 counts the number of symbols which belong to the type of the symbols which has been made effective in step S12, out of the symbols rearranged in step S15. Then, the main CPU 41 determines whether or not the counted number is equal to or more than 3.

When the main CPU 41 determines that a prize has been established, the main CPU 41 determines an amount of the normal payout, based on the type of symbols which has been made effective and the counted number of symbols (step S18). At this time, the main CPU 41 refers to the table data indicative of the relationships between the numbers of rearranged symbols and amounts of normal payouts (see FIG. 8).

FIG. 8 is a view illustrating the relationships between the numbers of rearranged symbols and amounts of normal payouts.

As illustrated in FIG. 8, the amounts of the normal payouts are defined in association with types and the numbers of rearranged symbols.

For example, in the case where the symbols “HEART” have been made effective, when three “HEARTs” are rearranged as illustrated in FIG. 1B, the amount of the normal payout is an amount corresponding to 20 coins. Further, when the symbols “A” have been made effective, when eight “A”s are rearranged in the symbol display area 100, the amount of the normal payout is an amount corresponding to 3×(8−2)=18 coins.

When the main CPU 41, the ROM 42 and the RAM 43 execute the processing in step S18 in cooperation with one another, the main CPU 41, the ROM 42 and the RAM 43 function as the controller for executing the processing (B) of the present invention. Here, step S18 corresponds to step (B) of the present invention.

After executing the processing in step S18, the main CPU 41 determines whether or not the special symbol stop-displayed in step S16 is “RED”, “BLUE” or “YELLOW” (step S19).

When the main CPU 41 determines that the stop-displayed special symbol is “RED”, “BLUE” or “YELLOW”, then the main CPU 41 executes amount-of-additional-payout determination processing (step S20).

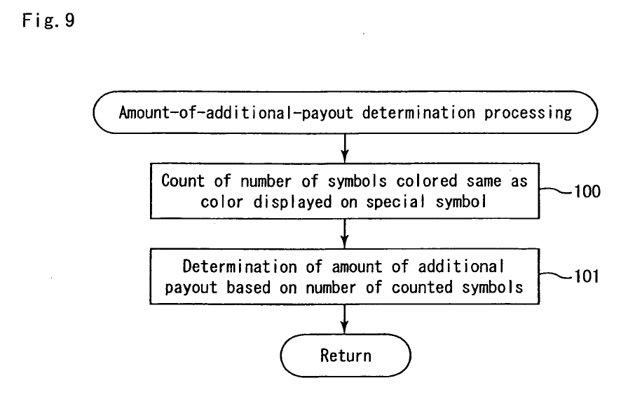

Hereinafter, with reference to FIG. 9, the amount-of-additional-payout determination processing will be described.

FIG. 9 is a flowchart illustrating a subroutine of the amount-of-additional-payout determination processing.

At first, the main CPU 41 counts the number of symbols colored the same as the color of the special symbol stop-displayed in step S16, out of the symbols rearranged in step S15 (step S100).

Then, the main CPU 41 determines an amount of additional payout, based on the counted number of symbols (step S101). In this processing, the main CPU 41 refers to the table data indicative of the relationship between special symbols and additional payouts (see FIG. 2).

For example, when the special symbol “RED” is stop-displayed, and also, the number of symbols colored red, out of the rearranged symbols, is 7, as illustrated in FIG. 1C, the amount of the additional payout is an amount corresponding to 8 coins (see FIG. 2).

Further, when the special symbol “YELLOW” is stop-displayed and, also, the number of symbols colored yellow, out of the rearranged symbols, is 10, the amount of the additional payout is an amount corresponding to 5×2¹⁰⁻⁵=160 coins (see FIG. 2).

After executing the processing in step S101, the main CPU 41 ends the present subroutine.

When the main CPU 41 determines, in step S19 in FIG. 5, that the stop-displayed special symbol is not any of “RED”, “BLUE” and “YELLOW”, the main CPU 41 determines whether or not the stop-displayed special symbol is “GOLD WILD” (step S21)

When the main CPU 41 determines that the stop-displayed special symbol is “GOLD WILD”, the main CPU 41 determines the amount of the additional payout (step S22).

In this processing, at first, the main CPU 41 determines whether or not “GOLD WILD” is included in the symbols stop-displayed in step S15. When no “GOLD WILD” is included, the main CPU 41 determines the amount of the additional payout to be 0. On the other hand, when “GOLD WILD” is included, the main CPU 41 determines the amount of the additional payout to be the amount obtained by multiplying the normal payout determined in step S18 by 9.

When the main CPU 41, the ROM 42 and the RAM 43 execute the processing in step S20 (the subroutine illustrated in FIG. 9) and step S22 in cooperation with one another, the main CPU 41, the ROM 42 and the RAM 43 function as the controller for executing the processing (D) of the present invention. Here, step S20 and step S22 correspond to step (D) of the present invention.

After executing the processing in step S20 or in step S22, the main CPU 41 pays out coins corresponding to the total sum of the amount of the normal payout determined in step S18 and the amount of the additional payout determined in step S20 or in step S22 (step S23).

For example, in the case where the symbols “HEART” have been made effective, when three “HEARTs” are rearranged as illustrated in FIG. 1B, the special symbol “RED” is stop-displayed as illustrated in FIG. 1C, and the number of symbols colored red, out of the rearranged symbols, is 7, then 20+8=28 coins are paid out.

Further, in the case where the symbols “A” have been made effective, when eight “A”s are rearranged in the symbol display area 100 and the special symbol “GOLD WILD” is stop-displayed, then 18+18×9=180 coins are paid out.

Here, in the case where the coins are accumulated, the main CPU 41 performs processing for increasing the number of credits stored in the RAM 43. On the other hand, in the case where coins are paid out, the main CPU 41 transmits a control signal to the hopper 66 to conduct a payout of a predetermined number of coins.

After executing the processing in step S23, the main CPU 41 ends the present subroutine.

When the main CPU 41, the ROM 42 and the RAM 43 execute the processing in step S23 in cooperation with one another, the main CPU 41, the ROM 42 and the RAM 43 function as the controller for executing the processing (E) of the present invention. Here, step S23 corresponds to step (E) of the present invention.

In the first embodiment, coins corresponding to an amount of the additional payout are paid out only when a prize is established, but coins corresponding to the amount of the additional payout are not paid out when no prize is established (refer to step S17). However, in the present invention, the amount of the additional payout may be determined, and game media corresponding to the determined amount of the additional payout may be paid out, even when no prize is established (the amount of the normal payout is 0).

Further, in the first embodiment, coins are paid out in step S23. However, game media paid out in the processing (E) of the present invention are not limited to coins, and examples thereof may include a bill, a medal and the like. Also, a token, electronic money, a ticket and the like may be paid out, as game media.

When the main CPU 41 determines, in step S17, that no prize has been established or when the main CPU 41 determines, in step S21, that the special symbol is not “GOLD WILD”, the main CPU 41 pays out coins corresponding to the amount of the normal payout determined in step S18 (step S24).

Next, the main CPU 41 determines whether or not the special symbol stop-displayed in step S16 is “BONUS IN” (step S25).

When the main CPU 41 determines that the stop-displayed special symbol is “BONUS IN”, the main CPU 41 determines the number-of-free-games C (step S26). In this processing, at first, the main CPU 41 counts the number of symbols colored the same as the color selected through the color selection buttons 110 in step S13 (the color indicated by the color data stored in the color storage area in the RAM 43), out of the symbols rearranged in step S15. Then, the main CPU 41 determines the number-of-free-games C to be the same number as the number of counted symbols.

For example, when the red color has been selected through the color selection buttons 110, when seven symbols colored red are rearranged as illustrated in FIG. 1B, the number-of-free-games C is determined to be 7.

Next, the main CPU 41 executes free-game execution processing (step S27).

When the main CPU 41 determines in step S25 that the special symbol is not “BONUS IN” or after executing the processing in step S27, the main CPU 41 ends the present subroutine.

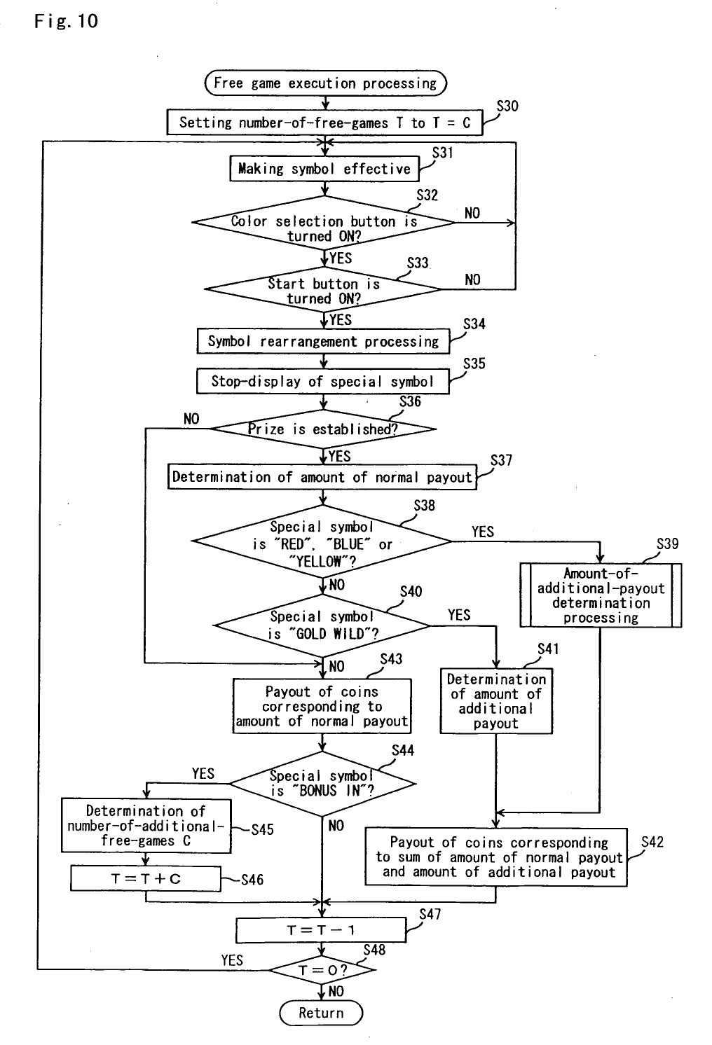

Hereinafter, with reference to FIG. 10, the free-game execution processing will be described.

FIG. 10 is a flowchart illustrating a subroutine of the free-game execution processing.

At first, the main CPU 41 sets the number-of-remaining-free-games T to T=C (C is the number C of free games determined in step S26 in FIG. 5), in a predetermined area (the number-of-free-games storage area) in the RAM 43 (step S30).

Next, the main CPU 41 executes processing for making symbols effective. In this processing, the main CPU 41 makes the symbols having been made effective at the end in step S12 in FIG. 5 to be effective. That is, when free games generate in the event that the special symbol “BONUS IN” is stop-displayed in a slot machine game, the same symbols as the symbols having been made effective in this slot machine game in which the special symbol “BONUS IN” has been stop-displayed are made effective during free games.

Next, the main CPU 41 executes processing in step S32 to step S43. The processing is the same as the processing in step S13 to step S24 in FIG. 5 and a description thereof will be omitted here.

When the main CPU 41 determines, in step S44, that the special symbol stop-displayed in step S35 is “BONUS IN”, the main CPU 41 determines the number-of-additional-free-games C (step S45). The processing for determining the number-of-additional-free-games C is the same as that described with reference to step S26 in FIG. 5 and a description thereof will be omitted here.

Next, the main CPU 41 sets the number-of-remaining-free-games T to T=T+C (C is the number-of-free-games C determined in step S45), in the number-of-free-games storage area in the RAM 43 (step S46). That is, in the case where the special symbol “BONUS IN” is stop-displayed during free games, the number of free games is increased.

When the main CPU 41 determines in step S44 that the special symbol is not “BONUS IN” or after executing the processing in step S42 or step S46, the main CPU 41 sets the number-of-remaining-free-games T to T=T−1, in the number-of-free-games storage area in the RAM 43 (step S47).

Subsequently, the main CPU 41 determines whether or not T is 0 (step S48).

When the main CPU 41 determines that T is not 0, the main CPU 41 returns the processing to step S31. On the other hand, when the main CPU 41 determines that T is 0, the main CPU 41 ends the present subroutine.

Hereinbefore, the first embodiment has been described.

In the first embodiment, there has been described the case where symbols themselves are colored. However, in the present invention, symbols may have a colored background. Also, there is no particular limitation on types and the number of colors of the symbols and the special symbols.

As described above, the slot machine 10 according to the first embodiment is configured to determine the amount of the additional payout, based on the colors which are elements easily and visually recognizable by humans. This configuration enables the player to grasp relatively easily the meaning of the payout of coins corresponding to the amount of the additional payout, namely the color of the rearranged symbols that causes the additional payout. Accordingly, it is possible to prevent the player from feeling that games are dryasdust games in which only the number of credits increase or decrease while the player is not aware of that, due to the difficulty in grasping the meaning of payouts.

Further, the amount of the additional payout is determined based on the color of the special symbol and the colors of the rearranged symbols, so that it is possible to cause the player to have interests and regards for the color of the stop-displayed special symbol and the colors of the rearranged symbols. Accordingly, it is possible to cause the player to concentrate on these colors, thereby immersing the player in games, and also possible to prevent the player from feeling that the games are dryasdust games.

Further, in the slot machine 10 according to the first embodiment, the amount of the additional payout is determined based on the number of symbols colored the same as the color of the stop-displayed special symbol (“RED”, “BLUE” and “YELLOW”), out of the rearranged symbols. Accordingly, the number of such symbols is a matter of significant concern for the player. Therefore, it is possible to cause the player to have a great fun in counting the number of such symbols during games, thereby preventing the player from feeling that games are dryasdust games.

Further, with the slot machine 10 according to the first embodiment, the amount of coins which the player can acquire as the additional payout is increased with increasing of the number of symbols colored the same as the color of the stop-displayed special symbol (“RED”, “BLUE” and “YELLOW”), out of rearranged symbols. Accordingly, when many symbols having a color are rearranged, when the special symbol having the same color is stop-displayed, the player can acquire a greater number of coins as the additional payout. Therefore, when many symbols having a color are rearranged, it is possible to cause the player to have a great sense of expectancy for stop-display of the special symbol having the same color.

Further, in the present invention, it is preferable to set the time interval from rearrangement of symbols to stop-display of a special symbol to a time interval which allows the player to grasp the rearranged symbols (for example, 10 seconds). This is for the following reason.

That is, the player can recognize which special symbol should be stop-displayed to receive a greater amount of a payout, only after grasping the rearranged symbols. Accordingly, in order to cause the player to have a sense of expectancy for a special symbol to be stop-displayed, there is a need for providing a time interval which allows the player to grasp the rearranged symbols.

Further, in the slot machine 10 according to the first embodiment, when the special symbol “GOLD WILD” is stop-displayed and at least a single symbol “GOLD WILD” is included in the rearranged symbols, the amount of the payout which the player can acquire increases as much as 10 times. Further, the special symbol “GOLD WILD” and the symbols “GOLD WILD” have a gold color which is very impressive to humans. Accordingly, when the special symbol “GOLD WILD” or the symbols “GOLD WILD” are displayed, it is possible to largely excite the player, and thereby immerse the player in games.

Further, in the slot machine 10 according to the first embodiment, free games are generated when the special symbol “BONUS IN” is stop-displayed. Further, the number of free games to be generated is determined, based on the number of rearranged symbols colored the same as the color that the player selected through the color selection buttons 110. Accordingly, the color selection through the color selection buttons 110 significantly affects the number of free games, namely the number of games which can be played for free, and therefore is an important selection for the player. By providing, to the player, the opportunity to make such an important selection, it is possible to immerse the player in games.

Further, when many symbols colored the same color as the color that the player selected through the color selection buttons 110 are rearranged, and also, the special symbol “BONUS IN” is stop-displayed, the player is allowed to play a greater number of free games. Accordingly, it is possible to cause the player to have a sense of expectancy for rearrangement of many symbols colored the same as the color that the player selected through the color selection buttons 110. Further, when many symbols colored the same as the color that the player selected through the color selection buttons 110 are rearranged, it is possible to cause the player to have a great sense of expectancy for stop-display of the special symbol “BONUS IN”.

### Second Embodiment

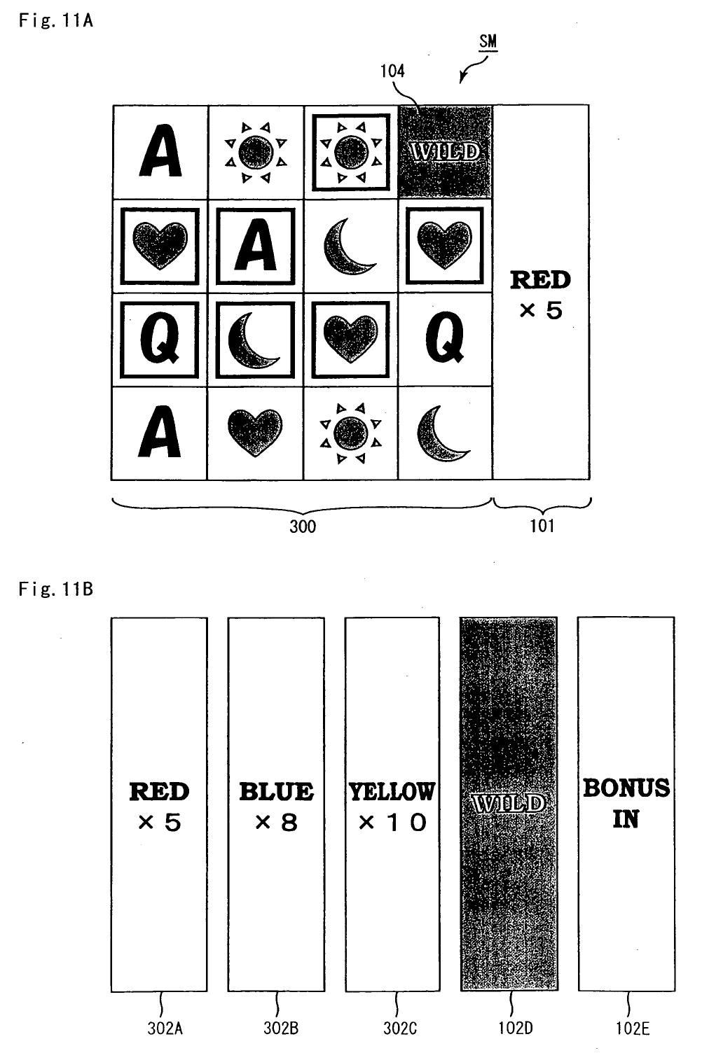

FIG. 11A is a view illustrating an exemplary symbol matrix according to the second embodiment.

FIG. 11B is a view illustrating a special symbol matrix according to the second embodiment.

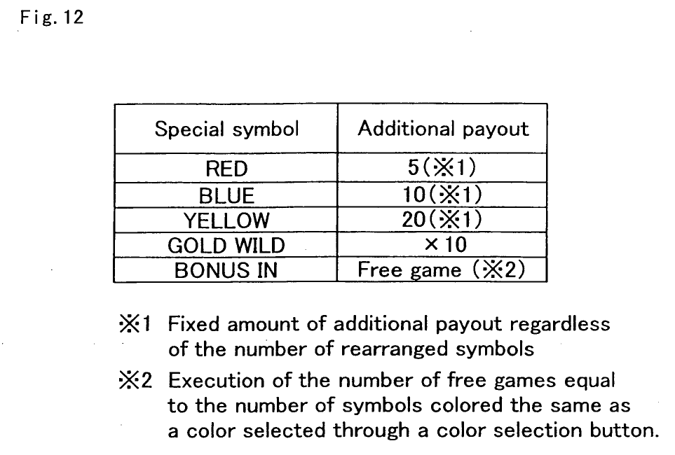

FIG. 12 is a view illustrating the relationships between special symbols and additional payouts according to the second embodiment.

In the following description, the same components as components of the slot machine 10 according to the first embodiment will be given the same reference numerals.

Further, the parts of the second embodiment to which description on the first embodiment can be applied will not be described.

In the first embodiment, the symbol display area 100 has been described as being capable of displaying a total of 12 symbols along 3 rows and 4 columns. On the contrary, as illustrated in FIG. 11A, in the second embodiment, a symbol display area 300 is capable of displaying a total of 16 symbols along 4 rows and 4 columns. In the present invention, there is no particular limitation on the number of the rows and the columns constituting the symbol display area, and also, there is no particular limitation of the number of symbols rearranged therein.

Further, in the first embodiment, the special symbol “RED” 102A, the special symbol “BLUE” 102B and the special symbol “YELLOW” 102C have been described as colored symbols with no characters displayed thereon (see FIG. 1D).

On the contrary, as illustrated in FIG. 11B, in the second embodiment, a special symbol “RED×5” 302A, a special symbol “BLUE×8” 302B and a special symbol “YELLOW×10” 302C have a number displayed thereon as well as a colors, respectively. These numbers are referred to, when the amount of the additional payout is determined.

The colors of the special symbols and the numbers displayed on the special symbols correspond to the additional payout condition of the present invention.

In the second embodiment, after a special symbol is stop-displayed in the special-symbol display area 101, the number of symbols colored the same as the color of the stop-displayed special symbol, out of the symbols rearranged in the symbol display area 300, is counted. Then, when the number of the counted symbols is equal to or more than the number displayed on the special symbol, the amount of the additional payout is determined. The amount of the additional payout to be determined is fixed, regardless of the number of the counted symbols (see FIG. 12).

For example, in the example illustrated in FIG. 11A, when the special symbol “RED×5” 302A is stop-displayed as the special symbol, more than 5 symbols (7 symbols) colored red which is the same as the color of the special symbol “RED×5” 302A are rearranged, and therefore, the amount of the additional payout is determined. In this case, the determined amount of the additional payout is an amount corresponding to 5 coins (see FIG. 12).

Further, although, in the example illustrated in FIG. 11B, there is illustrated a case where the special symbol “RED×5” 302A is colored red and also has a number of “5” displayed thereon, the special symbol “BLUE×8” 302B is colored blue and also has a number of “8” displayed thereon, and the special symbol “YELLOW×10” 302C is colored yellow and also has a number of “10” displayed thereon, these special symbols are merely examples, and the correspondence between the colors of the special symbols and the numbers displayed on the special symbols are not limited to the example.

In the second embodiment, as the special symbols colored red, there are a total of 16 types of special symbols each having a number in the range of 1 to 16. Further, as special symbols colored blue, there are a total of 16 types of special symbols each having a number in the range of 1 to 16. As special symbols colored yellow, there are a total of 16 types of special symbols each having a number in the range of 1 to 16.

The amounts of the normal payouts, the special symbol “GOLD WILD” 102D and the special symbol “BONUS IN” 102E are the same as those described in the first embodiment and a description thereof will be omitted here.

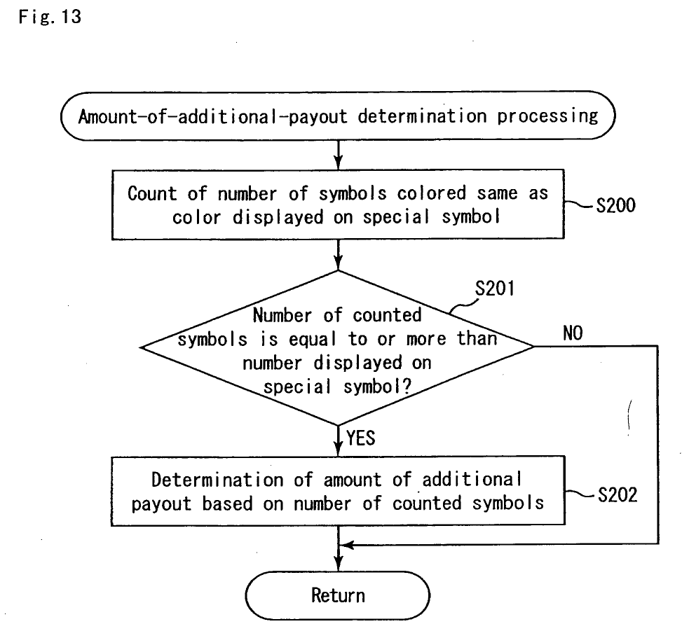

FIG. 13 is a flowchart illustrating a subroutine of amount-of-additional-payout determination processing according to the second embodiment.

This processing is processing which is called up and executed in step S20 in the slot machine game execution processing illustrated in FIG. 5. The parts of the slot machine game execution processing other than the amount-of-additional-payout determination processing are the same processing as those described in the first embodiment and a description thereof will be omitted here.

At first, the main CPU 41 counts the number of symbols colored the same as the color of the special symbol stop-displayed in the special-symbol display area 101, out of the symbols rearranged in the symbol display area 300 (step S200).

Next, the main CPU 41 determines whether or not the number of the counted symbols is equal to or more than the number displayed on the stop-displayed special symbol (step S201).

When the main CPU 41 determines that the number of symbols is equal to or more than the number displayed on the stop-displayed special symbol, the main CPU 41 determines the amount of the additional payout, based on the color of the special symbol (step S202). In this processing, the main CPU 41 refers to the table data indicative of the relationships between the special symbols and the additional payouts (see FIG. 12).

When the main CPU 41 determines in step S201 that the number of symbols is less than the number displayed on the stop-displayed special symbol or after executing the processing in step S202, the main CPU 41 ends the present subroutine.

When the main CPU 41, the ROM 42 and the RAM 43 execute the subroutine illustrated in FIG. 13 in cooperation with one another, the main CPU 41, the ROM 42 and the RAM 43 function as the controller for executing the processing (D) of the present invention. Further, step S200 to step S202 correspond to step (D) of the present invention.

With the slot machine 10 according to the second embodiment, when the number of symbols colored the same as the color of the stop-displayed special symbol (“RED”, “BLUE” and “YELLOW”), out of the rearranged symbols, is equal to or more than the number displayed on the special symbol (“RED”, “BLUE” and “YELLOW”), the additional payout is conducted. On the contrary, when the number of symbols colored the same as the color of the stop-displayed special symbol (“RED”, “BLUE” and “YELLOW”) is less than the number displayed on the special symbol (“RED”, “BLUE” and “YELLOW”), no additional payout is conducted. Accordingly, when the number of symbols is equal to or more than the number, it is possible to please the player, but when the number of symbols is less than the number, it is possible to disappoint the player. As described above, it is possible to cause the player to experience emotional ups and downs, thereby preventing the player from feeling that the games are dryasdust games.

In the second embodiment, when a special symbol “RED”, “BLUE” or “YELLOW” is stop-displayed, the amount of the additional payout is fixed, regardless of the number of symbols colored the same as the color of the stop-displayed special symbol, out of the rearranged symbols. However, in the present invention, the amount of the additional payout may be varied according to the number of symbols colored the same color as the color of the stop-displayed special symbol. For example, the amount of the additional payout may be increased with increasing of the number of symbols colored the same as the color of the stop-displayed special symbol.

In the second embodiment, when the special symbol “RED”, “BLUE” or “YELLOW” is stop-displayed, when the number of symbols colored the same as the color of the stop-displayed special symbol out of the rearranged symbols is equal to or more than the number displayed on the special symbol, the additional payout is conducted. However, in the present invention, the additional payout may be conducted, only when the number of symbols colored the same as the color of the stop-displayed special symbol out of the rearranged symbols is equal to the number displayed on the special symbol. In the case of employing this configuration, the rarity value of the additional payout is increased, thereby pleasing the player more largely in the event that the player can acquire the additional payout. In this case, amounts of coins to be paid out as the additional payout is preferably made greater than those in the second embodiment.

In the first and second embodiments, there have been described the cases where symbols are rearranged in the symbol matrix SM on the lower image display panel 16, and the special symbol is stop-displayed (the slot machine 10 is a so-called a video slot machine). However, the slot machine according to the present invention may be configured to rearrange symbols and also stop-display the special symbol, using so-called mechanical reels.

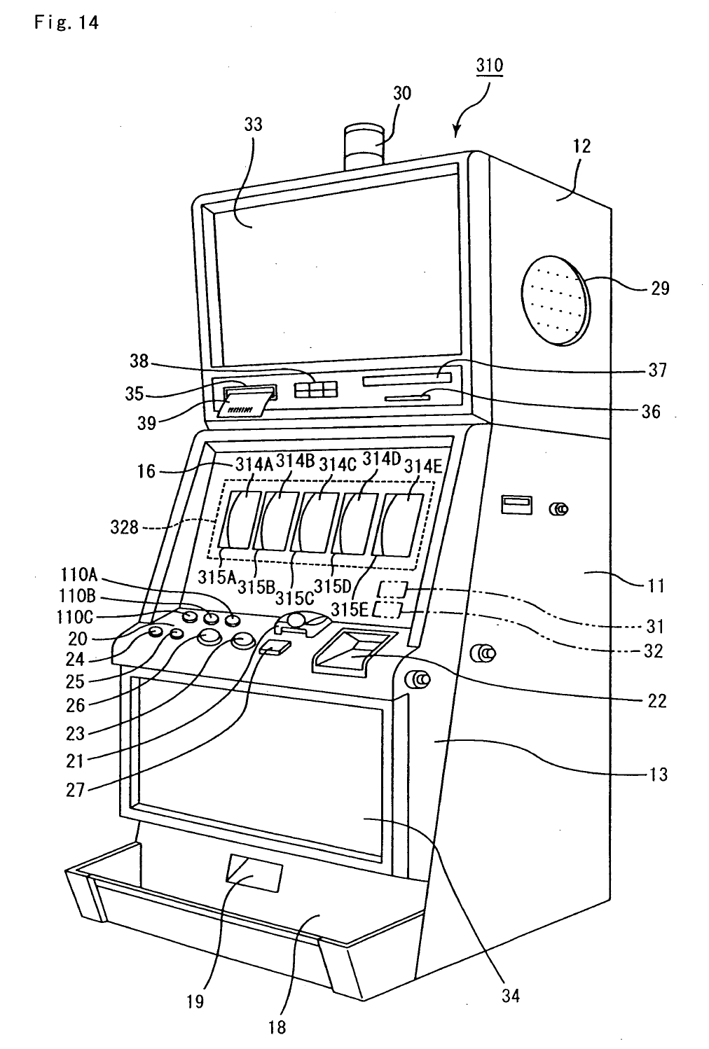

FIG. 14 is a perspective view illustrating the general appearance of a slot machine according to another embodiment.

In the following description, the components corresponding to those of the slot machine 10 will be designated by the same reference numerals.

Further, the slot machine 310 has substantially the same external appearance, the same circuit structure and the like as those of the slot machine 10 and also executes substantially the same flowcharts as those executed by the slot machine 10, except that it employs mechanical reels, and, therefore, only the mechanical reels will be described herein.

As illustrated in FIG. 14, 5 reels 314 (314A, 314B, 314C, 314D and 314E) are rotatably provided within a cabinet 11. On the outer peripheral surfaces of the reels 314A, 314B, 314C and 314D, there are drawn symbol sequences made of symbols of 6 types “Q”, “A”, “MOON”, “SUN”, “HEART” and “GOLD WILD”. On the other hand, on the outer peripheral surface of the reel 314E, there is drawn a special-symbol sequence constituted by special symbols of 5 types “RED”, “BLUE”, “YELLOW”, “GOLD WILD” and “BONUS IN”. Each of the symbols is colored any of red, blue and yellow, similarly to in the first embodiment and the second embodiment. Further, the special symbol “RED” is colored red, the special symbol “BLUE” is colored blue, the special symbol “YELLOW” is colored yellow, and the special symbol “GOLD WILD” is colored gold. These colors are applied to the outer peripheral surfaces of the reels 314.

At the center portion of the lower image display panel 16, there is provided a display area 328 which displays the symbols and the special symbols. Within the display area 328, there are formed five display windows 315 (315A, 315B, 315C, 315D and 315E) visible through their back surfaces. Further, the symbols drawn on the outer peripheral surfaces of the reels 314A, 314B, 314C and 314D are displayed on a three-by-three basis, through the display windows 315A, 315B, 315C, and 315D. Further, single special symbol drawn on the outer peripheral surface of the reel 314E is displayed through the display window 315E.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processing described in the present specification are to be executed by various types of devices, in principle. Further, other structures required for conducting each step will be apparent from the aforementioned description.

What is claimed as new and desired to be secured by Letters Patent of the United States is:

1. A slot machine comprising:
a display capable of rearranging a plurality of colored symbols or a plurality of symbols each having a colored background; and
a controller programmed to execute processing of:
(A) rearranging said plurality of symbols to said display;
(B) determining an amount of a normal payout, based on the numbers of symbols of respective types rearranged in said processing (A);
(C) determining an additional payout condition relating to colors;
(D) determining an amount of an additional payout, based on at least the colors of the symbols rearranged in said processing (A) or at least the colors of the backgrounds of the symbols, and the additional payout condition determined in said processing (C); and
(E) paying out game media corresponding to the amount of the normal payout determined in said processing (B) and game media corresponding to the amount of the additional payout determined in said processing (D).

2. The slot machine according to claim 1,
wherein
said processing (C) is processing for selecting a single color out of plural types of colors, and
said processing (D) is processing for determining the amount of the additional payout based on the number of symbols colored the same as the color determined in said processing (C) or the number of symbols each having a background colored the same as said color, out of the symbols rearranged in said processing (A).

3. The slot machine according to claim 1,
wherein
said processing (C) is processing for selecting a single color out of plural types of colors, and also determining a number to be referred to when the amount of the additional payout is determined, and
said processing (D) is processing for determining the amount of the additional payout, when the number of symbols colored the same as the color determined in said processing (C) or the number of symbols having a background colored the same as said color, out of the symbols rearranged in said processing (A), is equal to or more than the number determined in said processing (C).

4. The slot machine according to claim 1,
wherein
said processing (C) comprises processing of:
(C-1) varying and displaying a plurality of special symbols each having a different candidate condition displayed thereon to said display and then stop-displaying a single special symbol to said display, and
(C-2) determining the candidate condition displayed on the special symbol stop-displayed in said processing (C-1) as said additional payout condition.

5. A controlling method of a slot machine comprising the steps of:
(A) rearranging a plurality of colored symbols or a plurality of symbols each having a colored background;
(B) determining an amount of a normal payout, based on the numbers of symbols of respective type rearranged in said step (A);
(C) determining an additional payout condition relating to colors;
(D) determining an amount of an additional payout based on at least the colors of the symbols rearranged in said step (A) or at least the colors of the backgrounds of the symbols, and the additional payout condition determined in said step (C); and
(E) paying out game media corresponding to the amount of the normal payout determined in said step (B) and game media corresponding to the amount of the additional payout determined in said step (D).
